(19) United States
(12) Patent Application Publication
(10) Pub. No.: US 2024/0311284 A1
(43) Pub. Date: Sep. 19, 2024

(54) Comparison Based Autocorrelation in Load Testing

(71) Applicant: Micro Focus LLC, Santa Clara, CA (US)

(72) Inventors: Fei Gao, Shanghai (CN); Wei-Wei Zhang, Shanghai (CN); Bin Zhou, Shanghai (CN)

(73) Assignee: Micro Focus LLC, Santa Clara, CA (US)

(21) Appl. No.: 18/120,811

(22) Filed: Mar. 13, 2023

(51) Int. Cl. G06F 11/36

(52) U.S. Cl. CPC G06F 11/3692; G06F 11/3684

(57) ABSTRACT

A first execution of a test script is recorded. The recording of the first execution of the test script is of a first interaction between a communication device and an Application Under Test (AUT). First request and response data for the first execution of the test script is captured. A second execution of the test script is recorded. Second request and response data for the second execution of the test script is captured. The first execution of the test script and the second execution of the test script are isolated sessions. The first request and response data is compared to the second request and response data to find one or more varying response values. The one or more varying response values are searched to identify correlations. A second test script is automatically created based on the identified correlations.

### FIELD

The disclosure relates generally to testing of software applications and particularly to automatic generation of test scripts for testing software applications based on correlations.

### BACKGROUND

Currently, rule-based correlation of test scripts typically requires a large amount of computing resources and does not scale well. This is because every rule is searched in all requests and responses from the beginning to the end of a testing process. As a result, large amounts of CPU time and memory can be consumed. This can result in a test script taking hours or even crashing because of out-of-memory situations.

An alternative is to have a user manually reduce the correlations. However, this process is very error prone and sometimes it is not applicable. In addition, customers typically need customized rules, so fixed correlations are not always the best solution.

### SUMMARY

These and other needs are addressed by the various embodiments and configurations of the present disclosure. The present disclosure can provide a number of advantages depending on the particular configuration. These and other advantages will be apparent from the disclosure contained herein.

A first execution of a test script is recorded. The recording of the first execution of the test script is of a first interaction between a communication device and an Application Under Test (AUT). First request and response data for the first execution of the test script is captured. A second execution of the test script is recorded. Second request and response data for the second execution of the test script is captured. The first execution of the test script and the second execution of the test script are isolated sessions. The first request and response data is compared to the second request and response data to find one or more varying response values. The one or more varying response values are searched to identify correlations. A second test script is automatically created based on the identified correlations.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for identifying correlations to create test scripts.

FIG. 2 is a block diagram of a second illustrative system for identifying correlations to create test scripts.

FIG. 3 is a flow diagram of a process for identifying correlations to create test scripts.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

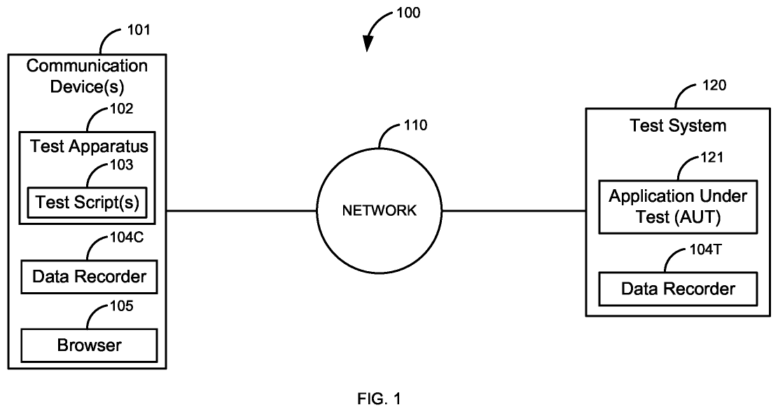

FIG. 1 is a block diagram of a first illustrative system 100 for identifying correlations to create test scripts 103. The first illustrative system 100 comprises one or more communication devices 101, a network 110, and a test system 120.

The communication device 101 can be or may include any device that can be used to test the Application Under Test (AUT) 121, such as a Personal Computer (PC), a server, a telephone, a video system, a tablet device, a notebook device, a smartphone, a laptop computer, and/or the like. Although FIG. 1 only shows a single communication device 101, the communication device 101 may comprise multiple communication devices 101. For example, multiple communication devices 101 may be employed to test the AUT 121 in parallel.

The communication device 101 further comprises a test apparatus 102, test scripts 103, a data recorder 104C (“C” stands for in the communication device 101), and a browser 105. The test apparatus 102 is a test environment that can be used to test the AUT 121. The test apparatus 102 comprises one or more test scripts 103. The test script(s) 103 may comprise any number/type of test scripts 103. For example, the test script(s) 103 may be used to test a graphical user interface (via the browser 105), used to test functionality of the AUT 121, used to test protocols supported by the AUT 121 (e.g., Hyper Text Transfer Protocol (HTTP)), and/or the like. Some of the test script(s) 103 may be automatically generated/modified based on other test script(s) 103.

The data recorder 104C is used to capture network traffic, such as, requests/responses (e.g., HTTP GETs/responses). In this embodiment, the data recorder 104 may reside in the communication device 101 or may reside in the test system 120 (i.e., data recorder 104T). The data recorder 104C can identify variances between the same tests and then create new test scripts 103 by correlating variances between the same test scripts 103. In one embodiment, the data recorder 104C is the only data recorder 104C (there is not data recorder 104T).

The browser 105 can be or may include any type of browser, such as, Google Chrome®, Internet Explorer®, Mozilla Firefox®, Apple Safari®, a headless browser, and/or the like. The test apparatus 102 may execute the test scripts 103 via the browser 105. Alternatively, the test scripts 103 may be executed without using the browser 105.

The network 110 can be or may include any collection of communication equipment that can send and receive electronic communications, such as the Internet, a Wide Area Network (WAN), a Local Area Network (LAN), a packet switched network, a circuit switched network, a cellular network, a combination of these, and/or the like. The network 110 can use a variety of electronic protocols, such as Ethernet, Internet Protocol (IP), Hyper Text Transfer Protocol (HTTP), JavaScript Object Notation (JSON), Web Real-Time Protocol (Web RTC), and/or the like. Thus, the network 110 is an electronic communication network configured to carry messages via packets and/or circuit switched communications.

The test system 120 can be any device that can host the AUT 121, such as, a web server, an application server, an embedded device, a Personal Computer (PC), and/or the like. The test system 120 may comprise an operating system that runs the AUT 121. The test system 120 further comprises the AUT 121, and a data recorder 104T.

The AUT 121 may be any type of application, such as, a web application, a social network application, a database application, a financial application, a communication application, a spreadsheet application, a computer application, and/or the like. The AUT 121 may be running in a container or virtual machine. The test scripts 103 are used to test features of the AUT 121.

The data recorder 104T (“T” stands for test system) may work similarly to the data recorder 104C, except that it works to capture and record requests/responses received/sent from the test system 120. The recorder 104T may be the only recorder 104 in the first illustrative system 100. The data recorder 104T can communicate with the test apparatus 102 to execute the test scripts 103 in the communication device 101 and to send updates of test scripts to the test apparatus 102.

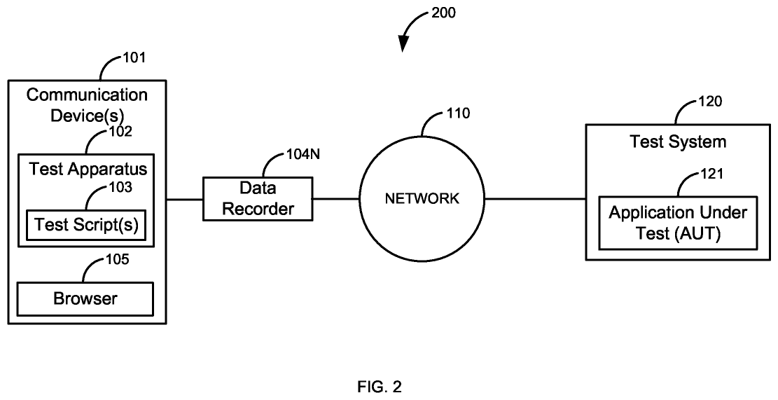

FIG. 2 is a block diagram of a second illustrative system 200 for identifying correlations to create test scripts 103. The second illustrative system 200 comprises one or more communication devices 101, a data recorder 104N (“N” stands for network based), the network 110, and the test system 120.

The main difference between FIG. 1 and FIG. 2 is that the data recorder 104N is between the communication device 101 and the test system 120. In FIG. 2, the data recorder 104N may be a proxy server that relays packets sent from the communication device 101 to test system 120 and relays packets sent from the test system 120/AUT 121 to the communication device 101. In this embodiment, there is not a data recorder 104 in either the communication device 101 or the test system 120.

Although the data recorder 104N is shown in series, the data recorder 104N may work like a network analyzer that monitors packets (does not relay packets) sent between the communication device 101 and the test system 120. In FIG. 2, the data recorder 104N can communicate with the test apparatus 102 to execute the test scripts 103 and send updates to the test script(s) 103.

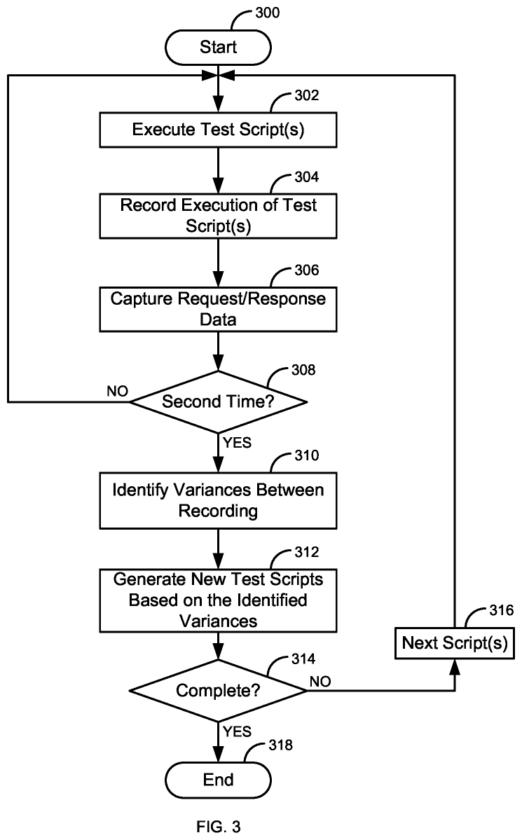

FIG. 3 is a flow diagram of a process for identifying correlations to create test scripts 103. Illustratively, the communication device(s) 101, the test apparatus 102, the test scripts 103, the data recorders 104C/103T/104N, the browser 105, the test system 120, and the AUT 121 are stored-program-controlled entities, such as a computer or microprocessor, which performs the method of FIG. 3 and the processes described herein by executing program instructions stored in a computer readable storage medium, such as a memory (i.e., a computer memory, a hard disk, and/or the like). Although the methods described in FIG. 3 are shown in a specific order, one of skill in the art would recognize that the steps in FIG. 3 may be implemented in different orders and/or be implemented in a multi-threaded environment. Moreover, various steps may be omitted or added based on implementation. The process of FIG. 3 may work with any of the embodiments described in FIGS. 1-2.

The process starts in step 300. The test apparatus 102 executes the test script(s) 103 in step 302. For example, the data recorder 104 may send a message to the test apparatus 102 to execute one or more test scripts 103 in step 302. The test script(s) 103 are typically User Interface (UI) test script(s) 103 that are executed from the browser 105. However, the test script(s) 103 may be executed without a browser 105. The data recorder 104 records execution of the test script(s) 103 in step 304. For example, the data recorder 104 may capture packets that are sent from the communication device 101 to the test system 120 and sent from the test system 120 to the communication device 101 during the execution of the test script(s) 103.

The data recorder 104 captures request/response data in step 306. For example, if the request is an HTTP GET that is sent to the AUT 121, the data recorder 104 will capture the HTTP GET and the corresponding response to the HTTP GET. The data recorder 104 determines, in step 308, if the test script(s) 103 has been executed a second time. If the test script(s) 103 has not been executed a second time, in step 308, the process goes back to step 302 to execute the test script(s) 103 a second time. In FIG. 3, each of the executions of the test script(s) 103 are isolated sessions. In other words, the first execution of the test script(s) 103 is run separately from the second execution of the test scripts 103.

Otherwise, if the test script(s) 103 has been executed twice in step 308, the data recorder 104 identifies variances in the response values in step 310. For example, if the request is the HTTP GET, the data recorder 104 determines if the response when the test script 103 was executed the first time is the same when the test script 103 was executed the second time. If the data changes between the recording of the test scripts 103 the first time and the recording of the test scripts 103 the second time, a variance is identified in step 310.

Below is an example of the variances for the first recording of the test scripts 103 during a login process and the second recording of the test scripts 103 during the login process.

First recording:
-----------------------------------------------------------------------
Request
POST /login HTTP/1.1
Host: xxx.net
{username: MyName, password, MyPassword}
-----------------------------------------------------------------------
Response
HTTP/1.1 200 OK
{token: 123456ABC}
-----------------------------------------------------------------------
Request
Get /main?token =123456ABC HTTP/1.1
Host: xxx.net
<html>....
-----------------------------------------------------------------------
Second Recording
-----------------------------------------------------------------------
Request
POST /login HTTP/1.1
Host: xxx.net
{username: MyName, password, MyPassword}
-----------------------------------------------------------------------
Response
HTTP/1.1 200 OK
{token: 582417639}
-----------------------------------------------------------------------
Request
Get /main? Token = 582417639 HTTP/1.1
Host: xxx.net
<html>....
-----------------------------------------------------------------------

In this example, the variance between the two recordings is that the token in the first recording (123456ABC) is different than the token in the second recording (582417639). By running the second recording of the test script 103, the variance can automatically be identified instead of having a user create a custom rule to identify the variance.

A more complicated example of a variance is shown below:

First Recording
-----------------------------------------------------------------------
Request
POST /login HTTP/1.1
Host: xxx.net
{username: MyName, password, MyPassword}
-----------------------------------------------------------------------
Response
HTTP/1.1 200 OK
E3ZhbHV1MTogMTExLCB2YWx1ZTI6IDIyMiwgLi4uIHRva2
-----------------------------------------------------------------------
Request
Get /main?token-123456ABC HTTP/1.1
Host: xxx.net
-----------------------------------------------------------------------
Response
HTTP/1.1 200 OK
<html>....
-----------------------------------------------------------------------
Second Recording
-----------------------------------------------------------------------
Request
POST /login HTTP/1.1
Host: xxx.net
{username: MyName, password, MyPassword}
-----------------------------------------------------------------------
Response
HTTP/1.1 200 OK
AIz123bqIANZ372B9AZqiN23A3ZmzqI32Zabrx2AEXMAzdm
-----------------------------------------------------------------------
Request
Get /main?token- 32AF1342B HTTP/1.1
Host: xxx.net
-----------------------------------------------------------------------
Response
HTTP/1.1 200 OK
<html>....
-----------------------------------------------------------------------

In this example, the encoded string in the first recording E3ZhbHV1MTogMTExLCB2YWx1ZTI6IDIyMiwgLi4uIHRva2 is different from the encoded string AIz123bqIANZ372B9AZqiN23A3ZmzqI32Zabrx2AEXMAzdm in the second recording. Likewise, the token in the first recording (123456ABC) is different from the token in the second recording (32AF1342B). By running the second recording of the same test script 103, the variances can now be automatically identified in step 310.

The data recorder 104 generates one or more new scripts based on the identified variances in step 312. For example, based on the variance in the token/encoded token in the examples above, the test script 103 is modified so that the variances are accounted for.

To illustrate, consider the following example. In a normal workflow of the HTTP protocol, the data recorder 104 generates an internal script (in memory, not a test script 103) that is created using the steps as below (The responses and requests are in each step's snapshot):

```
web_submit_data(″login″,
  ″Action=http://xxx.net/login″,
  ″Method=POST″,
  ITEMDATA,
  ″Name=username″, ″Value=MyName″, ENDITEM,
  ″Name=password″, ″Value=MyPassword″, ENDITEM,
  LAST);
web_url(″main page″,
  ″URL=http://xxx.net/main?token=123456ABC″,
  LAST);
```

The data recorder 104 correlates the steps to check the relationship between the responses and requests and modifies the test script 103 as shown below.

```
web_reg_save_param json(
  ″ParamName=logintoken ″,
  ″QueryString=$.token″,
  SEARCH_FILTERS,
  LAST);
web_submit_data(″login″,
  ″Action=http://xxx.net/login″,
  ″Method=POST″,
  ITEMDATA,
  ″Name=username″, ″Value=MyName″, ENDITEM,
  ″Name=password″, ″Value=MyPassword″, ENDITEM,
  LAST);
web_url(″main page″,
  ″URL=http://xxx.net/main?token={logintoken}″,
  LAST);
```

In the new workflow, the test script 103 is not initially recorded. A TruClient protocol is used to get a TruClient script as below (the initial test script 103). The TruClient protocol is where a user interaction with the AUT 121 is recorded as illustrated below.

truclient_step(″1″, ″Navigate to ′http://xxx.net/login′″);
truclient_step(″2″, ″Click on Username textbox″);
truclient_step(″3″, ″Type MyName in Username textbox″);
truclient_step(″4″, ″Type **** in Password passwordbox″);
truclient_step(″5″, ″Click on Login button″);
truclient_step(″6″, ″Click on main page″);

Then the script is replayed twice recorded the internal script contains basic web steps as shown below:

```
web_submit_data(″login″,
  ″Action=http://xxx.net/login″,
  ″Method=POST″,
  ITEMDATA,
  ″Name-username″, ″Value=MyName″, ENDITEM,
  ″Name=password″, ″Value=MyPassword″, ENDITEM,
  LAST);
web_url(″main page″,
  ″URL=http://xxx.net/main?token=123456ABC″,
  LAST);
```

This internal script, which contains basic web steps, is the same as normal workflow. However, each step has more snapshots to compare. In each step, the data recorder 104 compares the snapshots first to find the variances. Then the data recorder 104 then correlates the steps to check the relationship between the responses and requests to identify only in the variances. The data recorder 104 then creates the following new test script 103.

```
web_reg_save_param_json(
  ″ParamName=logintoken″,
  ″QueryString=$.token″,
  SEARCH_FILTERS,
  LAST);
web_submit_data(″login″,
  ″Action=http://xxx.net/login″,
  ″Method=POST″,
  ITEMDATA,
  ″Name=username″, ″Value=MyName″, ENDITEM,
  ″Name=password″, ″Value=MyPassword″, ENDITEM,
  LAST);
web_url(″main page″,
  ″URL=http://xxx.net/main?token-{logintoken}″,
  LAST);
```

Nothing changes for user, he/she just records the actions and gets the new test script 103. But in the workflow, the TruClient test script 103 is created first, and then it is replayed twice or more to get an internal HTTP script which contains more snapshots, which are correlated by comparing snapshots to get the new test script 103.

In these examples, the modified test script 103 may take different actions based on the variance. For example, the data recorder 104 may not flag the variance as an error, may ignore the variance, may identify the variance as a varying token, may identify the variance as changing data (e.g., data that changes during a flight reservation) and/or the like. In one embodiment the generated new test script 103 may be a completely new test script 103. In other words, instead of modifying an existing test script 103, a completely new test script 103 is generated.

The data recorder 104 determines, in step 314, if the process is complete. If the process is complete in step 314, the next script is determined in step 316 and the process goes back to step 302. Otherwise, if the process is complete, in step 318, the process ends in step 320.

Once the new test script(s) 103 are generated/modified in step 312, the data recorder 104 may execute the new test script(s) 103. For example, a set of test scripts 103 may be executed twice to identify all the variances in the test script(s) 103. The test script(s) 103 can then be automatically modified as described in FIG. 3. Once all the test script(s) 103 are modified, the new test script(s) 103 can then be executed.

This process dramatically improves the testing process by identifying variances and automatically updating the test script(s) 103. In addition, the improved process dramatically reduces the amount of work that a user does in manually modifying the test script(s) 103 to accommodate the variances. The end result is that the testing process is much more efficient and accurate than existing methods. In addition, other factors are improved, such as, memory usage and test script 103 execution time.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
record a first execution of a first test script, wherein the recoding of the first execution of the first test script is of a first interaction between a communication device and an Application Under Test (AUT);
capture first request and response data for the first execution of the first test script;
record a second execution of the first test script, wherein the recoding of the second execution of the first test scripts is of a second interaction between the communication device and the AUT;
capture second request and response data for the second execution of the first test script, wherein the first execution of the first test script and the second execution of the first test script are isolated sessions;
compare the first request and response data to the second request and response data to find one or more varying response values;
search the one or more varying response values to identify correlations; and
automatically create a second test script based on the identified correlations.

2. The system of claim 1, wherein the first test script is a Hyper Text Transport Protocol (HTTP) test script.

3. The system of claim 1, wherein the one or more varying response values comprises a HTTP token.

4. The system of claim 1, wherein the one or more varying response values comprises an encoded value.

5. The system of claim 1, wherein automatically creating the second test script comprises modifying the first script based on the varying response values.

6. The system of claim 1, wherein automatically creating the second test script comprises one or more of: not flagging the one or more variances as an error, ignoring the one or more variances, identifying the one or more variances as a varying token, and identifying the one or more variances as dynamically changing data.

7. The system of claim 1, wherein the microprocessor readable and executable instructions further cause the microprocessor to:
execute the second test script; and
capture third request and response data.

8. A method comprising:
recording, by a microprocessor, a first execution of a first test script, wherein the recoding of the first execution of the first test script is of a first interaction between a communication device and an Application Under Test (AUT);
capturing, by the microprocessor, first request and response data for the first execution of the first test script;
recording, by the microprocessor, a second execution of the first test script, wherein the recoding of the second execution of the first test scripts is of a second interaction between the communication device and the AUT;
capturing, by the microprocessor, second request and response data for the second execution of the first test script, wherein the first execution of the first test script and the second execution of the first test script are isolated sessions;
comparing, by the microprocessor, the first request and response data to the second request and response data to find one or more varying response values;
searching, by the microprocessor, the one or more varying response values to identify correlations; and
automatically creating, by the microprocessor, a second test script based on the identified correlations.

9. The method of claim 8, wherein the first test script is a Hyper Text Transport Protocol (HTTP) test script.

10. The method of claim 8, wherein the one or more varying response values comprises a HTTP token.

11. The method of claim 8, wherein the one or more varying response values comprises an encoded value.

12. The method of claim 8, wherein automatically creating the second test script comprises modifying the first script based on the varying response values.

13. The method of claim 8, wherein automatically creating the second test script comprises one or more of: not flagging the one or more variances as an error, ignoring the one or more variances, identifying the one or more variances as a varying token, and identifying the one or more variances as dynamically changing data.

14. The method of claim 8, wherein the microprocessor readable and executable instructions further cause the microprocessor to:
execute the second test script; and
capture third request and response data.

15. A non-transient computer readable medium having stored thereon
instructions that cause a processor to execute a method, the method comprising: instructions to:
record a first execution of a first test script, wherein the recoding of the first execution of the first test script is of a first interaction between a communication device and an Application Under Test (AUT);
capture first request and response data for the first execution of the first test script;
record a second execution of the first test script, wherein the recoding of the second execution of the first test scripts is of a second interaction between the communication device and the AUT;
capture second request and response data for the second execution of the first test script, wherein the first execution of the first test script and the second execution of the first test script are isolated sessions;
compare the first request and response data to the second request and response data to find one or more varying response values;
search the one or more varying response values to identify correlations; and
automatically create a second test script based on the identified correlations.

16. The non-transient computer readable medium of claim 15, wherein the first test script is a Hyper Text Transport Protocol (HTTP) test script.

17. The non-transient computer readable medium of claim 15, wherein the one or more varying response values comprises a HTTP token.

18. The non-transient computer readable medium of claim 15, wherein the one or more varying response values comprises an encoded value.

19. The non-transient computer readable medium of claim 15, wherein automatically creating the second test script comprises modifying the first script based on the varying response values.

20. The non-transient computer readable medium of claim 15, wherein automatically creating the second test script comprises one or more of: not flagging the one or more variances as an error, ignoring the one or more variances, identifying the one or more variances as a varying token, and identifying the one or more variances as dynamically changing data.
